(19) United States
(12) Patent Application Publication
(10) Pub. No.: US 2018/0069220 A1
(43) Pub. Date: Mar. 8, 2018

(54) COMPOSITE SEPARATOR AND LITHIUM-ION BATTERY USING THE SAME

(71) Applicant: CONTEMPORARY AMPEREX TECHNOLOGY CO., LIMITED, Ningde City (CN)

(72) Inventors: Chenglong YUAN, Ningde City (CN); Ning PENG, Ningde City (CN); Chao GUO, Ningde City (CN); Shengwu ZHANG, Ningde City (CN)

(21) Appl. No.: 15/809,224

(22) Filed: Nov. 10, 2017

Related U.S. Application Data
(63) Continuation of application No. PCT/CN2015/078702, filed on May 11, 2015.

(51) Int. Cl. H01M 2/16; H01M 10/0525

(52) U.S. Cl. CPC H01M 2/1686; H01M 10/0525

(57) ABSTRACT

There is provided a composite separator for a lithium-ion battery, including a polyolefin substrate and a coating layer containing a binder and inorganic particles formed on a surface of the polyolefin substrate, a hydrogen bond being formed between the binder and the inorganic particles. Also provided are a method for preparing the composite separator for a lithium-ion battery and a lithium-ion battery using the composite separator. The composite separator of the present application increases adhesion force between the substrate and the inorganic particles, thereby reducing detachment of the inorganic particles. By using the composite separator, the product quality of the battery is improved, and the risk of influencing the safety performance of the battery caused by the detachment of the inorganic particles in a production process is reduced.

### CROSS-REFERENCE TO RELATED APPLICATIONS

The present application is a continuation of International application No. PCT/CN2015/078702, filed on May 11, 2015, the content of which is incorporated herein by reference in its entirety.

### TECHNICAL FIELD

The present application relates to the field of lithium-ion battery technologies and, particularly relates to a composite separator for a lithium-ion battery and a lithium-ion battery using the composite separator.

### BACKGROUND

A lithium-ion battery has been widely used in mobile communication and electronic consumer products (for example, cell phones, notebook computers, etc.) because of its unique advantages of high power density. The currently developed lithium-ion battery with large capacity has been widely applied as a power source of electric vehicles. Generally, the lithium-ion battery includes a positive electrode, a negative electrode, a separator, an electrolyte, and cell structural parts. The separator is a key component in the lithium-ion battery, which is insulated from electrons but conductive for ions, and can separate a cathode from an anode of the lithium-ion battery, thereby preventing short circuit caused by direct contact of two electrodes of the cell. However, the separator is generally a porous membrane made of polyolefin polymers, and such polymers contract in high temperature environment, which results in large contact area between the positive electrode and the negative electrode of the cell, and rapidly generates large amount of heat, causing thermal runaway, burning or explosion of the battery. Such problem has become a key issue to be solved. After years researches, an inorganic ceramic-coated separator, due to its excellent high-temperature resistance and safety performance, has been widely applied in the power battery field.

The inorganic ceramic-coated separator is formed by coating a layer of inorganic ceramic particles on a single surface or double surfaces of a porous polyolefin substrate. Since the inorganic ceramic powder material has hydrophilic surface with poor surface compatibility with a hydrophobic separator substrate, such as polyethylene (PE), polypropylene (PP), etc., it readily causes quality problems such as poor cohesive force of the coating layer during coating the ceramic powders, surface cracking, aging and change in porosity, etc., further causing detachment of the powders during subsequent winding of the separator. Moreover, the ceramic particles detached from the surface of the separator are sandwiched between the separator and the electrode, so that the separator will be punctured during a hot pressing test of the cell, causing a low rate of finished products. Even the cell passes the hot pressing test, the ceramic particles sandwiched between the separator and the electrode will cause micro-short circuit within the separator, high probability of subsequent self-discharging of the cell, and even severe safety problems (e.g., internal short circuit). In order to solve this problem, one object of the present application is to provide a method for preparing a ceramic-coated separator, which can improve cohesion force of the ceramic coating layer and interfacial adhesion force of the separator, thereby effectively solving the powder detachment and peeling problems of the ceramic layer coated on the surface of the polyolefin separator, and improving product quality and safety performance of the battery.

### SUMMARY

A purpose of the present application is to provide a method for preparing a separator for a lithium-ion battery, which can improve cohesion force of the inorganic particle coating layer. Interfacial adhesion force of the composite separator prepared by such method is also enhanced, which solves the problem of powder detachment of inorganic particles during preparing and winding of the composite separator. The composite separator of the present application combines an inorganic particle material with a specific functional group and a binder with a functional group matching with the specific functional group of the inorganic particle material, so that interaction (e.g., binding of hydrogen bonds) of the functional groups increases the adhesion force between the inorganic particles, thereby reducing the powder detachment and peeling problems due to weak adhesion force of the inorganic particles.

One aspect of the present application provides a composite separator for a lithium-ion battery, including a polyolefin substrate, and a coating layer formed on a surface of the polyolefin substrate. The coating layer includes a binder and inorganic particles, and a hydrogen bond is formed between the binder and the inorganic particles.

The binder includes an aqueous binder containing —CO— or —CN functional group; and the inorganic particles contain —OH functional group.

The binder is formed by polymerizing one or more monomers selected form a group consisting of acrylate, alkenyl carboxylate, and alkenyl nitrile.

The acrylate refers to a monomer having a structural formula shown in formula 1:

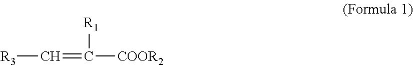

In formula 1, R₁ can be independently H or alkyl having 1-3 carbon atoms: R₂ can be independently alkyl having 1-4 carbon atoms; and R₃ can be independently H or alkyl having 1-3 carbon atoms.

The alkenyl carboxylate refers to a monomer having a structural formula shown in formula 2:

R₄—CH₂COOR₅ (Formula 2)

In formula 2, R₅ can be independently alkenyl having 2-4 carbon atoms; and R₄ can be independently H or alkyl having 1-3 carbon atoms.

The alkenyl nitrile refers to a monomer having a structural formula as shown in formula 3:

R₆—CN (Formula 3)

In formula 3, R₆ can be independently alkenyl having 2-5 carbon atoms.

Examples of the alkyl can include methyl, ethyl, propyl, isopropyl, and butyl. Examples of the alkenyl can include vinyl, propenyl, allyl, isopropenyl, butenyl, and pentenyl.

The acrylate is preferably methyl acrylate, ethyl acrylate, methyl methacrylate, or ethyl methacrylate.

The alkenyl carboxylate is preferably vinyl acetate.

The alkenyl nitrile is preferably acrylonitrile.

The binder can be polymerized by a conventional polymerization method, for example, bulk polymerization method and emulsion polymerization method. Reagents and additives in polymerization can be added during the polymerization according to actual need. Examples of the reagents and additives in polymerization may include initiator, catalyst, emulsifier, dispersant, molecular weight regulator, and terminator, etc.

The binder can further include carboxymethyl cellulose (CMC).

The inorganic particles are selected from a group consisting of boehmite particles, aluminum hydroxide particles, magnesium hydroxide particles, and combinations thereof.

A particle size D50 of the inorganic particles is 0.3 μm<D50<3 nm, and a particle size D100 of the inorganic particles is 1 μm<D100<15 μm.

A thickness of the composite separator is in a range of 6 μm-30 μm.

A thickness of the coating layer is in a range of 2 μm-6 μm.

The coating layer is formed on a single surface or double surfaces of the polyolefin substrate.

Another aspect of the present application provides a method for preparing a composite separator for a lithium-ion battery, using inorganic powder particles with a crystal structure containing covalent bond —OH functional group, and an aqueous binder containing —CO— or —CN functional group.

The composite separator of the present application is prepared by using inorganic powder particles with a crystal structure containing specific covalent bond —OH functional group, and a corresponding aqueous binder containing —CO— or —CN functional group to form an inorganic particle coating layer. The covalent bond —OH contained in the crystal structure and the —CO— or —CN contained in the binder form hydrogen bonding force shown as follows:

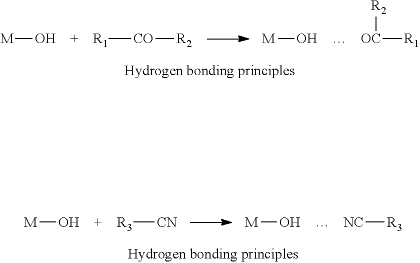

Since the inorganic particles and the binder form a strong hydrogen bonding force, the adhesion force of the inorganic particles of the composite separator of the present application is greater than the coating layer of the separator disclosed in related literature using oxide ceramics such as aluminum oxide, silicon dioxide, etc.

Therefore, compared with the existing composite separator of the lithium-ion battery, the composite separator of the present application at least has the following beneficial effects:

The composite separator prepared in the present application adopts a binder and inorganic particles with specific functional groups, so that mutual coupling between the binder and the inorganic particles is enhanced, the hydrogen bonding improves the adhesion force of the coating layer, thereby reducing the problems of detachment of the inorganic particles due to poor adhesion force of the coating layer and surface cracking during actual coating process. In the present application, product quality of the lithium-ion battery using the composite separator is improved, and the risk of influencing the safety performance of the battery due to detachment of the inorganic particles is reduced.

### BRIEF DESCRIPTION OF DRAWINGS

FIG. 1 illustrates a comparison graph of self-discharging test results of cells assembled with different separators in embodiments of the present application and comparison examples.

### DESCRIPTION OF EMBODIMENTS

The composite separator, the method for preparing the composite separator, and the lithium-ion battery using the composite separator of the present application are illustrated with reference to the embodiments.

### Embodiment 1

Aluminum hydroxide (Al(OH)₃) particles (D50, 1.5 μm; D100, 10 μm) are selected as inorganic particles; and polymethyl methacrylate is selected as a binder. Firstly, deionized water is added into a planetary stirring tank, then the aluminum hydroxide particles are tiled within the deionized water to reach a solid content of 60%, then a mixture of the above described compositions is stirred for 60 min, successively, the binder polymethyl methacrylate is added into the mixture at twice, the attached compositions on a tank wall is scraped once, and then the mixture is further stirred for 180 min at a temperature of 25-35° C., so as to obtain a slurry. Subsequently, the slurry is transferred into an ultrafine dispersion machine and is dispersed. The dispersed slurry is uniformly coated on a single surface of a PE separator to form a coating layer with a thickness of 3 μm. The coated separator is then dried in an oven and winded, so as to obtain a composite separator with an aluminum hydroxide particle coating layer for a lithium-ion battery. A thickness of the obtained composite separator is 15 μm.

### Embodiment 2

Boehmite particles (D50, 1.6 μm; D100, 12 μm) are selected as inorganic particles; and polyvinyl acetate is selected as a binder. A slurry is obtained according to the stirring procedure in Embodiment 1, and the obtained slurry is uniformly coated on a single surface of a PE separator to form a coating layer with a thickness of 3 μm. The coated separator is then dried in an oven and winded, so as to obtain a composite separator with a boehmite particle coating layer for a lithium-ion battery. A thickness of the obtained composite separator is 15 μm.

### Embodiment 3

Boehmite particles (D50, 1.6 μm; D100, 12 μm) are selected as inorganic particles, and polymethyl acrylate is selected as a binder. A slurry is obtained according to the stirring procedure in Embodiment 1, and the obtained slurry is uniformly coated on a single surface of a PE separator to form a coating layer with a thickness of 3 μm. The coated separator is then dried in an oven, and winded, so as to obtain a composite separator with a boehmite particle coating layer for a lithium-ion battery. A thickness of the obtained composite separator is 15 μm.

### Embodiment 4

Magnesium hydroxide particles containing —OH (D50, 1.4 μm; D100, 10 μm) are selected as inorganic particles, and a binder is acrylic emulsion (manufactured by Qingdao Dike New Material Corporation, Ltd). A slurry is obtained according to the stirring procedure in Embodiment 1, and the obtained slurry is uniformly coated on a single surface of a PE separator to form a coating layer with a thickness of 3 μm. The coated separator is then dried in an oven and winded, so as to obtain a composite separator with a magnesium hydroxide coating layer for a lithium-ion battery. A thickness of the obtained composite separator is 15 μm.

### Embodiment 5

Boehmite particles (D50, 1.5 μm; D100, 12 μm) are selected as inorganic particles, and a binder is a water soluble acrylonitrile containing —CN functional group (LA132, manufactured by Xuzhou Zhuoyuan Chemical Corporation, Ltd). A slurry is obtained according to the stirring procedure in Embodiment 1, and the obtained slurry is uniformly coated on a single surface of a PE separator to form a coating layer with a thickness of 3 μm. The coated separator is then dried in an oven, and winded, so as to obtain a composite separator with a boehmite particle coating layer for a lithium-ion battery. A thickness of the obtained composite separator is 15 μm.

### Embodiment 6

In order to further improve the stability of the slurry and coating adhesion force, 0.4% CMC binder is further added in the formulation of Embodiment 3. The obtained slurry is coated and dried, and the obtained separator is winded, so as to obtain a composite separator for a lithium-ion battery. A thickness of the obtained composite separator is 15 μm.

### Embodiment 7

Boehmite particles (D50, 1.6 μm; D100, 12 μm) are selected as inorganic particles, and a binder is polymethyl acrylate copolymer. A slurry is obtained according to the stirring procedure in Embodiment 1, and the obtained slurry is uniformly coated on double surfaces of a PE separator to form two coating layers (each coating layer has a thickness of 2 μm) on the surfaces of the PE separator. The coated separator is then dried in an oven, and is winded, so as to obtain a composite separator with two boehmite particle coating layers for a lithium-ion battery. A thickness of the obtained composite separator is 6 μm.

### Comparison Example 1

Polyvinyl acetate is selected as a binder, and conventional aluminum oxide inorganic particles without covalent bond —OH are used to prepare aluminum oxide ceramic particles. A slurry containing the binder and the ceramic particles is obtained according to the stirring procedure in Embodiment 1, and the obtained slurry is uniformly coated on a single surface of a PE separator to form a coating layer with a thickness controlled in a range of 2-4 μm. The coated separator is then dried and winded, so as to obtain a composite separator with a ceramic coating layer for a lithium-ion battery.

### Comparison Example 2

Boehmite particles are selected as inorganic particles, and PVDF polymer without —CO— or —CN is used as a binder. A slurry containing the inorganic particles and the binder is obtained according to the stirring procedure in Embodiment 1, and the obtained slurry is uniformly coated on a single surface of a PE separator to form a coating layer with a thickness controlled in a range of 2-4 μm. The coated separator is then dried and winded, so as to obtain a composite separator with a boehmite particle coating layer for a lithium-ion battery.

Preparation of Lithium-Ion Battery:

Lithium iron phosphate (LFP) is used as a cathode active material. 90 wt % LFP active material is added into N-methyl-2-pyrrolidone (NMP) solvent, then 5 wt % acetylene black as a conductive agent and 5 wt % polyvinylidene fluoride (PVDF) as a binder are added, stirred, and dispersed so as to form a cathode slurry. The obtained cathode slurry is uniformly coated on an aluminum foil current collector with a thickness of 20 μm, then dried, and cold pressed so as to form a cathode plate.

Graphite (C) is used as an anode active material. 92 wt % graphite (C) is added into a deionized water solvent, then 3 wt % carbon black as a conductive agent, and 1.5 wt % hydroxymethyl cellulose (CMC) and 3.5 wt % styrene-butadiene rubber (SBR) as the binder are added, stirred, and dispersed so as to form an anode slurry. The obtained anode slurry is uniformly coated on a copper foil current collector with a thickness of 8 μm, then dried, and cold pressed so as to form a anode plate.

The anode plate and cathode plate as prepared above and the eight different composite separators from Embodiment 1-6 and Comparison examples 1-2 are winded to form cell assembles, respectively. Each cell assembly is hot pressed, packaged, and then injected with an electrolyte solution (electrolyte: 1 mol/L lithium hexafluorophosphate, solvent (volume ratio): vinyl carbonate:dimethyl carbonate=1:2), so as to obtain a lithium-ion battery.

### Test Example 1: The Cohesion Force of the Coating Layers of Different Composite Separators Coated with the Coating Layers is Analyzed

Test samples are the different composite separators with coating layers for lithium-ion batteries obtained according to Embodiments 1-7, and contrast samples are the composite separator prepared by using aluminum oxide particles without covalent bond —OH in Comparison example 1 and the composite separator prepared by using boehmite particles and the binder without —CO— or —CN in Comparison example 2. The cohesion force of the coating layers is tested by a method as follows: a green glue is adhered on a surface of the composite separator, then a 50N compression roller is used to roll on the green glue adhered on the composite separator for three times, and then a tesometer is used to 180° peel the green glue with a speed of 5 mm/min. The tested results are shown in Table 1. It can be known from Table 1 that: the adhesion force of the coating layer in the composite separators prepared by the method of the present application is greater than that of Comparison examples 1-2, and the improvement on cohesion force of the coating layer can reduce the powder detachment and peeling problems of the inorganic particles in a subsequent process.

TABLE 1
Test result of cohesion force of coating layers of different separators in the
Embodiments and Comparison examples

| | Embod- | Embod- | Embod- | Embod- | Embod- | Embod- | Embod- | | |
|---|---|---|---|---|---|---|---|---|---|
| Test | iment | iment | iment | iment | iment | iment | iment | Comparison | Comparison |
| Object | 1 | 2 | 3 | 4 | 5 | 6 | 7 | example 1 | example 2 |
| Adhesion | 6.5 | 7.2 | 8.7 | 7.5 | 8.3 | 9.8 | 9.0 | 5.5 | 5.6 |
| force of | | | | | | | | | |
| the | | | | | | | | | |
| coating | | | | | | | | | |
| layer/N | | | | | | | | | |

### Test Example 2: Comparison of Short Circuit Rate During Assembling and Hot Pressing of the Cell

The cathode plate, the anode plate, and the several different ceramic-coated separators obtained in Embodiment 1-7 and Comparison examples 1-2 are winded to form different cell assemblies. Each cell assembly is hot pressed with a force of 1000 kgf under a temperature of 80° C., and then tested for short circuit by a Hi-pot tester (voltage: 200V; internal resistance: 20MΩ). Internal short circuit results of cells with different ceramic separators are provided in Table 2. It can be known from the testing results that, the short circuit rate of cells using the composite separators prepared with boehmite ceramic particles containing —OH and binder containing —CO— or —CN in the Embodiments is significantly lower than that of the cells in Comparison examples 1-2. This is because adhesion force of the coating layer formed by boehmite ceramic particles containing covalent bond —OH and the binder containing —CO— or —CN is increased due to the hydrogen bonding effect during the preparation of the composite separator. While the adhesion force of the coating layer is relatively small, when it is formed by aluminum oxide without covalent bond —OH and the binder containing —CO— or —CN, or formed by boehmite ceramic particles containing covalent bond —OH and PVDF without —CO— or —CN, thus ceramic particles easily detach and get sandwiched between the electrode plate and the separator during cutting and winding of the composite separator, resulting in that the separator is punctured by the ceramic particles under high pressure. Therefore, ceramic particle black points can be seen on the surface of the separator when the cell is disassembled.

TABLE 2
Short circuit results of cells formed by ceramic separators

| | Embod- | Embod- | Embod- | Embod- | Embod- | Embod- | Embod- | | |
|---|---|---|---|---|---|---|---|---|---|
| Test | iment | iment | iment | iment | iment | iment | iment | Comparison | Comparison |
| Object | 1 | 2 | 3 | 4 | 5 | 6 | 7 | example 1 | example 2 |
| Short | 0.15% | 0.11% | 0.05% | 0.12% | 0.09% | 0.02% | 0.03% | 0.25% | 0.23% |
| circuit | | | | | | | | | |
| rate | | | | | | | | | |

### Test Example 3: Comparison of Self-Discharging Rates of Lithium-Ion Batteries Assembled with Different Separators

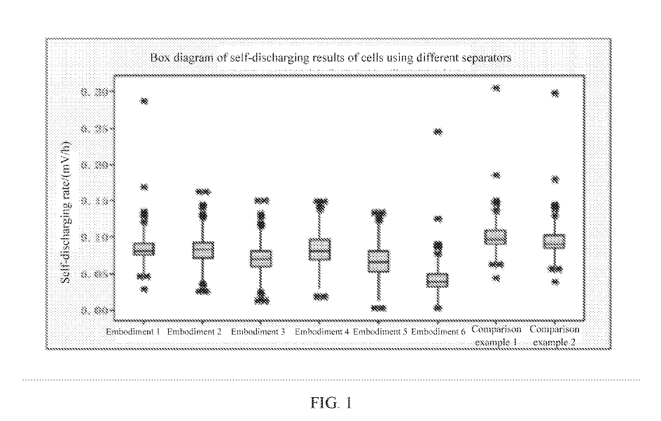

Self-discharging rates of the above prepared lithium-ion batteries using ceramic-coated separators obtained in different embodiments and comparison examples are tested for comparison. The batteries are fully charged to 3.65V, and voltages of the tested batteries are tested and recorded as V₀; the batteries are then let standby for 30 days at a high environment temperature of 45° C. and the voltage is tested again and recorded as V₁. Self-discharging result of the lithium-ion battery within unit time (i.e., self-discharging rate) is calculated by an equation: Self-discharging rate=(V₀−V₁)/(30*24 h), so as to obtain the unit time self-discharge results of lithium-ion batteries prepared by using different separators, as shown in FIG. 1. It can be known from FIG. 1 that, self-discharging rates of the lithium-ion batteries assembled by using the separators prepared in Embodiment 1-6 are lower than self-discharging rates of the lithium-ion batteries assembled by using the separators prepared in Comparison examples land 2. The principles lie in that: since the cohesion force of the coating layers of the ceramic-coated separators prepared in Comparison examples 1 and 2 is small during entire preparation of the separators, and the ceramic particles easily detach and get sandwiched inside the cell, and the sandwiched ceramic particles puncture the separator after charge-discharge test, resulting in micro-short circuit inside the battery and causing irreversible reaction, further speeding self-discharging rate within the battery.

In summary, based on comparison of the test data, we can conclude that, adhesion force of the coating layer of the composite separator prepared by using boehmite inorganic ceramic particles, short circuit rate of cells using the composite separator, and self-discharging rate of batteries using the composite separator are better than the existing aluminum oxide ceramic-coated separator; in addition, from the contrast data of Embodiment 6, it can be found that the separator prepared by using a composite binder of polymethyl acrylate and CMC demonstrates the optimum performance. By comparing data of Embodiment 7 and Embodiment 3, it can be found that the cohesion force of the coating layer and cell short circuit situation of a double-surface coated separator is better than those of a single-surface coated separator.

The embodiments are merely used to explain the invention concept of the present application, rather than limit the present application. It should be understood that, the present application can further include many other embodiments, and those skilled in the art can also make various changes and modifications to the present application without departing from the spirit and essence of the present application, and all those changes and modifications shall fall into the protection scope of the claims of the present application.

What is claimed is:

1. A composite separator for a lithium-ion battery, comprising a polyolefin substrate and a coating layer formed on a surface of the polyolefin substrate, the coating layer comprising a binder and inorganic particles, wherein a hydrogen bond is formed between the binder and the inorganic particles.

2. The composite separator for a lithium-ion battery according to claim 1, wherein the binder comprises an aqueous binder containing —CO— or —CN functional group, and the inorganic particles contain —OH functional group.

3. The composite separator for a lithium-ion battery according to claim 2, wherein the binder is formed by polymerizing one or more monomers selected from a group consisting of acrylate, alkenyl carboxylate, and alkenyl nitrile.

4. The composite separator for a lithium-ion battery according to claim 2, wherein the binder further comprises carboxymethyl cellulose.

5. The composite separator for a lithium-ion battery according to claim 2, wherein the inorganic particles are selected from a group consisting of boehmite particles, aluminum hydroxide particles, magnesium hydroxide particles, and combinations thereof.

6. The composite separator for a lithium-ion battery according to claim 2, wherein D50 of the inorganic particles is smaller than 3 μm, and D100 of the inorganic particles is smaller than 15 μm.

7. The composite separator for a lithium-ion battery according to claim 1, wherein a thickness of the composite separator is in a range of 6 μm-30 μm.

8. The composite separator for a lithium-ion battery according to claim 1, wherein a thickness of the coating layer is in a range of 2-6 μm.

9. The composite separator for a lithium-ion battery according to claim 1, wherein the coating layer is formed on a single surface or double surfaces of the polyolefin substrate.

10. A lithium-ion battery, comprising the composite separator for a lithium-ion battery according to claim 1.
